(19) United States
(12) Patent Application Publication
(10) Pub. No.: US 2023/0206648 A1
(43) Pub. Date: Jun. 29, 2023

(54) APPARATUS AND METHOD WITH DRIVING CONTROL

(71) Applicant: Samsung Electronics Co., Ltd., Suwon-si (KR)

(72) Inventors: Paul Barom JEON, Seoul (KR); Dokwan OH, Hwaseong-si (KR)

(73) Assignee: Samsung Electronics Co., Ltd., Suwon-si (KR)

(21) Appl. No.: 17/888,056

(22) Filed: Aug. 15, 2022

(30) Foreign Application Priority Data
Dec. 23, 2021 (KR) 10-2021-0186105

(51) Int. Cl. G06V 20/58; G06V 20/59; G06V 40/10; G06T 7/70; G06T 3/00; B60W 40/08

(52) U.S. Cl. CPC G06V 20/58; G06V 20/59; G06V 40/10; G06T 7/70; G06T 3/0018; B60W 40/08; G06T 2207/30196; G06T 2207/30261; G06T 2207/30268; B60W 2420/42; B60W 2556/20

(57) ABSTRACT

Disclosed are apparatuses and methods for controlling driving of a vehicle, the method including obtaining a first image captured by a first ultra-wide-angle lens disposed on a first position in a vehicle, obtaining a second image captured by a second ultra-wide-angle lens disposed on a second position in the vehicle, monitoring a state of a driver and an occupant of the vehicle based on the first image and the second image, detecting an object in a blind spot area based on a matching of the first image and the second image, and generating information for control of the vehicle based on a result of the monitoring and a result of the detecting of the object.

### CROSS-REFERENCE TO RELATED APPLICATIONS

This application claims the benefit under 35 USC § 119(a) of Korean Patent Application No. 10-2021-0186105, filed on Dec. 23, 2021 in the Korean Intellectual Property Office, the entire disclosure of which is incorporated herein by reference for all purposes.

### BACKGROUND

### 1. Field

The following description relates to an apparatus and method with driving control.

### 2. Description of Related Art

Autonomous driving technology may include technology to support driving. For example, a driver monitoring system (DMS) may be a camera-based system to detect signs of whether a driver is sleepy or distracted and may provide driver assistance functions for driving, such as issuing a warning function to the driver. In addition to the DMS, an occupant monitoring system (OMS) may determine a state of an occupant (or a passenger) and may provide a customized environment for an identified passenger, such as detecting whether a child is present in a stopped vehicle, and then may notify the driver.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided processor-implemented method with driving control, the method including obtaining a first image captured by a first ultra-wide-angle lens disposed on a first position in a vehicle, obtaining a second image captured by a second ultra-wide-angle lens disposed on a second position in the vehicle, monitoring a state of a driver and an occupant of the vehicle based on the first image and the second image, detecting an object in a blind spot area based on a matching of the first image and the second image, and generating information for control of the vehicle based on a result of the monitoring and a result of the detecting of the object.

The detecting of the object in the blind spot area may include obtaining information of an object not detected in the first image based on the second image, based on a matching relationship between an object detected in the first image and an object detected in the second image.

The detecting of the object in the blind spot area may include identifying an object in the blind spot area detected in both the first image and the second image by matching the first image and the second image, and obtaining recognition information of the identified object based on first recognition information of the identified object detected in the first image and second recognition information of the identified object detected in the second image.

The obtaining of the recognition information of the identified object may include obtaining recognition information of the identified object by calculating a weighted sum of the first recognition information and the second recognition information based on a reliability of the first image corresponding to the identified object and a reliability of the second image corresponding to the identified object.

The detecting of the object in the blind spot area may include identifying, in the blind spot area, an object detected in both the first image and the second image by matching the first image and the second image, and obtaining position information of the identified object based on first position information of the identified image detected in the first image and second position information of the identified image detected in the second image.

The obtaining of the position information of the identified object may include obtaining the position information of the identified object by calculating a weighted sum of the first position information and the second position information based on a reliability of the first image corresponding to the identified object and a reliability of the second image corresponding to the identified object.

The obtaining of the position information of the identified object may include obtaining the position information of the identified object by correcting the first position information and the second position information based on a difference between the first position and the second position.

The detecting of the object in the blind spot area may include obtaining recognition information of the object comprised in the blind spot area, and obtaining position information of the object comprised in the blind spot area.

The monitoring of the state of the driver and the occupant of the vehicle based on the first image and the second image may include detecting the driver of the vehicle and the occupant of the vehicle based on information of an inner area of the vehicle in the first image and the second image, and monitoring the detected state of the driver and the detected state of the occupant.

The first ultra-wide-angle lens may be disposed on the first position may include a driver monitoring system (DMS) camera for capturing a front seat of the vehicle, and the second ultra-wide-angle lens may be disposed on the second position may include an occupant monitoring system (OMS) camera for capturing a back seat of the vehicle.

In another general aspect, there is provided an apparatus with driving control, the apparatus including one or more processors configured to obtain a first image captured by a first ultra-wide-angle lens disposed on a first position in a vehicle, obtain a second image captured by a second ultra-wide-angle lens disposed on a second position in the vehicle, monitor a state of a driver and an occupant of the vehicle based on the first image and the second image, detect an object in a blind spot area based on a matching of the first image and the second image, and generate information for control of the vehicle based on a result of the monitoring and a result of the detecting of the object.

The one or more processors may be configured to obtain information of an object not detected in the first image based on the second image, based on a matching relationship between an object detected in the first image and an object detected in the second image.

The one or more processors may be configured to identify an object in the blind spot area detected in both the first image and the second image by matching the first image and the second image, and obtain recognition information of the identified object based on first recognition information of the identified object detected in the first image and second recognition information of the identified object detected in the second image.

The one or more processors may be configured to obtain recognition information of the identified object by calculating a weighted sum of the first recognition information and the second recognition information based on a reliability of the first image corresponding to the identified object and a reliability of the second image corresponding to the identified object.

The one or more processors may be configured to identify, in the blind spot area, an object detected in both the first image and the second image by matching the first image and the second image, and obtain position information of the identified object based on first position information of the identified image detected in the first image and second position information of the identified image detected in the second image.

The one or more processors may be configured to obtain the position information of the identified object by calculating a weighted sum of the first position information and the second position information based on a reliability of the first image corresponding to the identified object and a reliability of the second image corresponding to the identified object.

The one or more processors may be configured to obtain the position information of the identified object by correcting the first position information and the second position information based on a difference between the first position and the second position.

The one or more processors may be configured to obtain recognition information of the object comprised in the blind spot area, and obtain position information of the object comprised in the blind spot area.

The one or more processors may be configured to detect the driver of the vehicle and the occupant of the vehicle based on information of an inner area of the vehicle in the first image and the second image, and monitor the detected state of the driver and the detected state of the occupant.

In another general aspect, there is provided a vehicle including a first ultra-wide-angle lens configured to capture a first image, the first ultra-wide-angle lens being disposed on a first position in the vehicle, a second ultra-wide-angle lens configured to capture a second image, the second ultra-wide-angle lens being disposed on a second position in a vehicle, non-transitory computer-readable storage medium storing the first image, the second image, and instructions, and one or more processors configured to execute the instructions to configure one or more processors to monitor a state of a driver and an occupant of the vehicle based on the first image and the second image, detect an object in a blind spot area based on a matching of the first image and the second image, and generate information to control the vehicle based on a result of the monitoring and a result of the detecting of the object.

The first position may correspond to a center of a front row of the vehicle, and the first ultra-wide-angle lens may be further configured to capture a front seat of the vehicle.

The second position may correspond to a center of a back row of the vehicle, and the second ultra-wide-angle lens may be further configured to capture a back seat of the vehicle.

The one or more processors may be configured to determine a presence of a passenger in the vehicle based on the first image and the second image.

Other features and aspects will be apparent from the following detailed description, the drawings, and the claims.

### BRIEF DESCRIPTION OF THE DRAWINGS

FIG. 1 illustrates an example of operations of a driving control method.

FIG. 2 illustrates an example of a position in a vehicle in which an ultra-wide-angle lens is provided.

FIG. 3 illustrates an example of a blind spot area in a driving environment.

FIG. 4 illustrates an example of an angle of view of an ultra-wide-angle lens.

FIG. 5 illustrates an example of an image matching.

FIG. 6 illustrates an example of a driving control apparatus of a vehicle.

FIG. 7 illustrates an example of a driving control apparatus of a vehicle.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

Although terms of “first,” “second,” or “third” may be used herein to describe various members, components, regions, layers, or sections, these members, components, regions, layers, or sections are not limited by these terms. Rather, these terms are used only to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Throughout the specification, when a component is described as being “connected to,” “coupled to,” or “joined” another component, it may be directly “connected to,” “coupled to,” or “joined” the other component, or there may be one or more other components intervening therebetween. In contrast, when an element is described as being “directly connected to,” or “directly coupled to,” or “directly joined” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

The terminology used herein is for describing various examples only and is not to be used to limit the disclosure. The articles “a”, “an”, and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, examples will be described in detail with reference to the accompanying drawings. When describing the examples with reference to the accompanying drawings, like reference numerals refer to like components and a repeated description related thereto will be omitted.

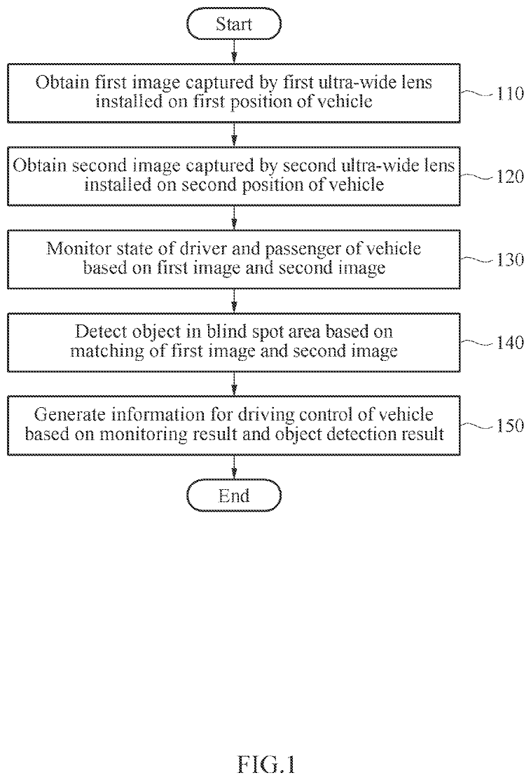

FIG. 1 illustrates an example of operations of a driving control method.

Referring to FIG. 1, a driving control method may include obtaining a first image captured by a first ultra-wide-angle lens, of a first camera, installed on a first position in a vehicle in operation 110, obtaining a second image captured by a second ultra-wide-angle lens, of a second camera, installed on a second position in the vehicle in operation 120, monitoring a state of a driver and a passenger of the vehicle based on the first image and the second image in operation 130, detecting an object in a blind spot area based on a matching of the first image to the second image in operation 140, and generating information for driving control of the vehicle based on the monitoring result and the object detection result in operation 150.

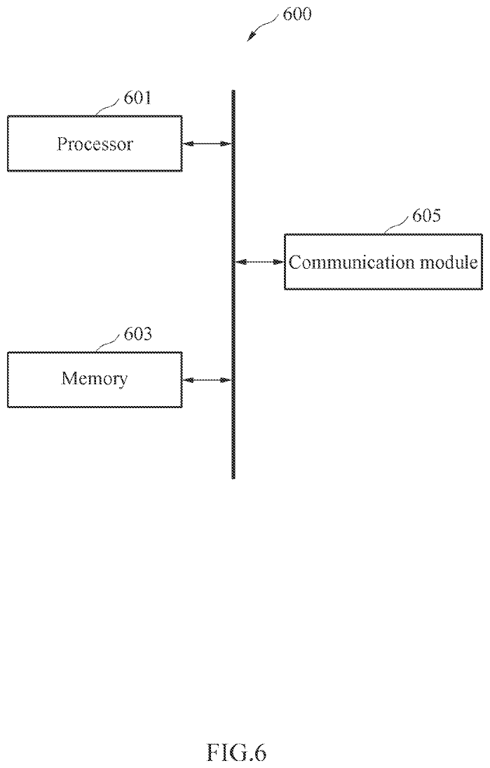

The driving control method may be performed by one or more processors of an apparatus for driving control of the vehicle. A non-limiting example of an apparatus for providing driving information is described in detail below. The operations 110 through 150 illustrated in FIG. 1 may be performed in the illustrated order and method. However, the order of one or more of the operations 110 through 150 may be changed, one or more of the operations 110 through 150 may be omitted, and/or one or more of the operations 110 through 150 may be performed in parallel or simultaneously without departing from the spirit and scope of the illustrated examples. One or more blocks of FIG. 1, and combinations of the blocks, can be implemented by special purpose hardware-based computer, such as a processor, that perform the specified functions, or combinations of special purpose hardware and computer instructions. For example, operations of the method may be performed by a computing apparatus (e.g., the driving control apparatus of FIG. 6).

Operations 110 and 120 may include obtaining a plurality of images through a plurality of ultra-wide-angle lenses installed or disposed on different positions in the vehicle.

A wide-angle lens may be a lens having a smaller focal length than a standard lens, which may be a lens having a focal length with a perspective most similar to that of a human eye. An ultra-wide-angle lens may be a lens having a smaller focal length than a wide-angle lens. For example, in a 35 millimeters (mm) format (135 film), a lens having a focal length of 24 mm or less may be classified as an ultra-wide-angle lens, and a lens having a focal length of 25 mm or more may be classified as a wide-angle lens. For another example, in an advanced photo system type-C (APS-C) standard, a lens having a focal length of 16 mm or less may be classified as an ultra-wide-angle lens, and a lens having a focal length of 17 mm or more and 23 mm or less may be classified as a wide-angle lens. In other words, the ultra-wide-angle lens may be differentiated from the wide-angle lens based on a predetermined standard and may correspond to a lens having a wider angle of view because the ultra-wide-angle lens has a smaller focal length than the wide-angle lens.

When the ultra-wide-angle lens is installed or disposed inside a vehicle, an image may be obtained by capturing the inside of the vehicle as well as the outside of the vehicle through the ultra-wide-angle lens having a wide angle of view. The ultra-wide-angle lens may be installed or disposed on a plurality of positions including a first position and a second position in the vehicle. For example, an ultra-wide-angle lens installed or disposed on the first position in the vehicle may include a driver monitoring system (DMS) camera for capturing a front seat of the vehicle, and an ultra-wide-angle lens installed or disposed on the second position may include an occupant monitoring system (OMS) camera for capturing a back seat of the vehicle. To differentiate between the ultra-wide-angle lenses and label the ultra-wide-angle lenses, the ultra-wide-angle lens installed on the first position may be referred to as a first ultra-wide-angle lens, and the ultra-wide-angle lens installed on the second position may be referred to as a second ultra-wide-angle lens, and the image obtained from the first ultra-wide-angle lens may be the first image, and the image obtained from the second ultra-wide-angle lens may be referred to as the second image.

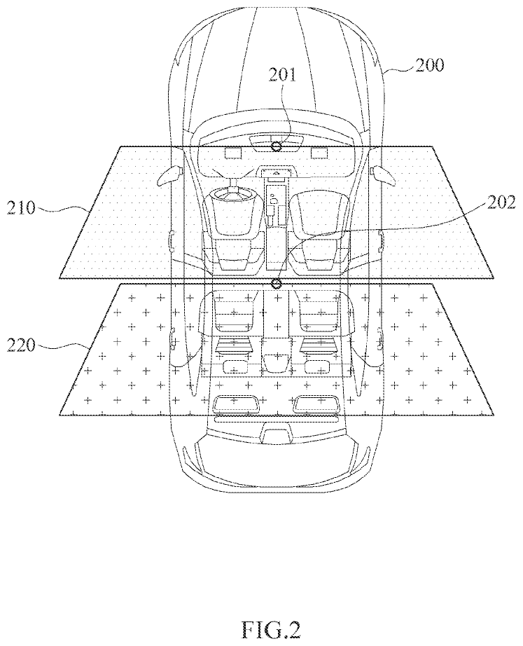

For example, referring to FIG. 2, an ultra-wide-angle lens may be installed or disposed in a center 201 of a front row of a vehicle (e.g., the vehicle 200) to capture a front seat of the vehicle and a center 202 of a back row of the vehicle to capture a back seat of the vehicle. In an example, although an ultra-wide-angle lens may be installed on various positions in the vehicle, the ultra-wide-angle lens may be installed on the center 201 of the front row of the vehicle and the center 202 of the back row as an example described herein, as illustrated in FIG. 2. Here, the first position may refer to the center 201 of the front row of the vehicle, and the second position may refer to the center 202 of the back row of the vehicle.

The first image capturing the inside of the front seat of the vehicle and the outside of the vehicle may be obtained from the first ultra-wide-angle lens installed or disposed on the first position in the vehicle, and the second image capturing the back seat of the vehicle and the outside of the vehicle may be obtained from the second ultra-wide-angle lens installed or disposed on the second position in the vehicle. For example, referring to FIG. 2, the image capturing the inside of the front row of the vehicle including a driver's seat and a passenger seat of the vehicle corresponding to an angle of view 210 and left and right-side images of the vehicle may be obtained from the first ultra-wide-angle lens installed on the front row of the vehicle. In addition, an image of an inner part of the back row of the vehicle including a back seat of the vehicle corresponding to an angle of view 220 and left and right-side images of the vehicle may be obtained from the second ultra-wide-angle lens installed on the back row of the vehicle. When an ultra-wide-angle lens is used, an angle of view of a camera may be wider than that of a standard lens or a wide-angle lens, and left and right-side images of the vehicle that are not included in the angle of view of the standard lens or the wide-angle lens may be obtained.

Operation 130 may include detecting a driver and a passenger of the vehicle in the first image and the second image and monitoring the detected states of the driver and the passenger. The driver and the passenger of the vehicle may be detected in the first image and the second image based on information associated with an inner area of the vehicle. The information associated with an inner area of the vehicle may include information associated with an area corresponding to an inner part of the vehicle, differentiated from an external part of the vehicle, in the first image and the second image and information associated with a seat position in the vehicle.

The passenger inside the vehicle and a person outside the vehicle may be classified and recognized as different classes in the first image and the second image. For example, an area corresponding to the inside of the vehicle and an area corresponding to the outside of the vehicle may be recognized separately, and a human object recognized in the area inside the vehicle may be recognized as a driver or a passenger in the first image and the second image. Meanwhile, a pedestrian outside the vehicle, or a passenger or driver of another vehicle, may be recognized as a different type of object differentiated from the driver or the passenger of the vehicle.

The inner area and the external area of the vehicle may be differentiated from one another by scene segmentation and/or an object detection algorithm and may be differentiated from one another through a determination (e.g., a calculation) based on information associated with a size including a width and length of the vehicle and information associated with a capturing environment including a focal length of an ultra-wide-angle lens that captures an image.

A driver may be differentiated from among passengers in a vehicle based on a position of the driver's seat. For example, when a left side of a front row corresponds to the driver's seat in a vehicle (e.g., a vehicle operating in South Korea), a person detected at a position corresponding to the left side of the front row in the first image may be recognized as the driver.

For example, a processor (e.g., one or more processors) may monitor a state of the driver located in the front row of the vehicle based on the first image and/or the second image, and when a passenger other than the driver is detected in the first image and/or the second image, a state of the other passengers may be monitored. The monitored state of the driver may be a state related to the driver's driving recognized in the image, and may include, for example, a state related to whether the driver is looking forward and a state related to whether the driver is holding the steering wheel. Specifically, the processor may detect the driver based on the position of the driver's seat in the first image and/or the second image and may determine whether the driver is looking forward by tracking the driver's gaze. A position of the driver's hand(s) and a position of the steering wheel may determine whether the driver is holding the steering wheel. The monitored state of the passenger may be information associated with the passenger recognized in the image (e.g., the presence of a passenger seated in the passenger seat based on the position of the passenger seat or the presence or absence of a passenger seated in the backseat based on the position of the back seat).

A monitoring target may be determined based on a position in a vehicle on which the ultra-wide-angle lens is installed. For example, the driver and the other passengers in the passenger seat may be monitored in the first image obtained from a first ultra-wide-angle lens installed on the front row of the vehicle, and the passengers in the back seat of the vehicle may be monitored in a second image obtained from a second ultra-wide-angle lens installed on the back row of the vehicle.

Operation 140 may include detecting an object based on the matching of the first image and the second image in a blind spot area separated from the inner area of the vehicle.

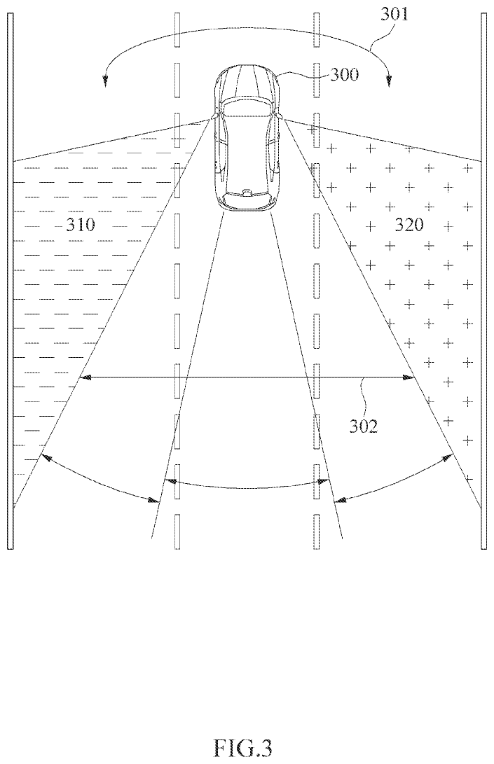

The blind spot area may correspond to an invisible area surrounding the vehicle that is not included in viewing angles of side mirrors and internal mirrors of the vehicle and a front view angle of the driver. For example, referring to FIG. 3, areas 310 and 320 that are not included in a front view angle 301 of the driver of the vehicle (e.g., the vehicle 300) and viewing angles 302 of side mirrors and internal mirrors of the vehicle may correspond to a blind spot area.

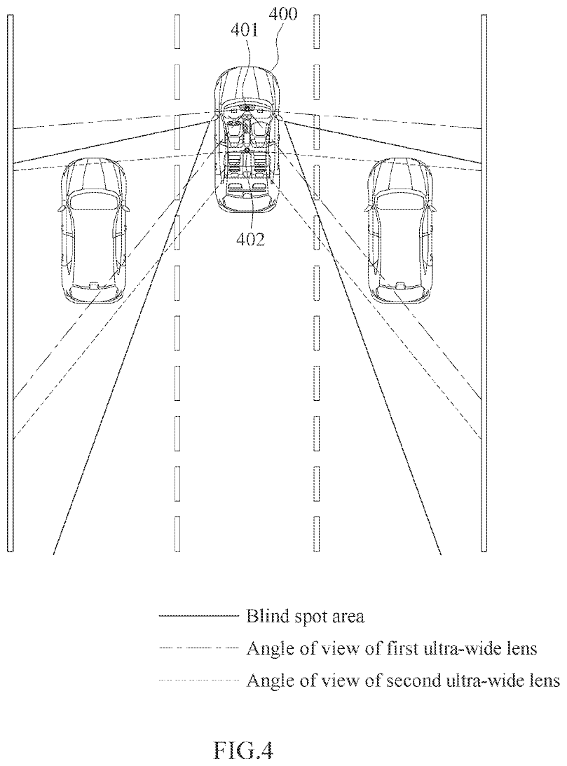

An image including at least a partial area of the blind spot area may be obtained from an ultra-wide-angle lens installed on the vehicle. For example, referring to FIG. 4, the first image obtained from the first ultra-wide-angle lens installed on a first position 401 of the vehicle (e.g., the vehicle 400) may include a partial area of the blind spot area, and the second image obtained from an ultra-wide-angle lens installed on a second position 402 of the vehicle may include a partial area of the blind spot area. Since the first image and the second image are images obtained from ultra-wide-angle lenses installed on different positions, such images may include areas of different blind spot areas.

An object in the blind spot area may be detected based on the first image and the second image. For example, an object detected in the blind spot area may include a vehicle, a pedestrian, a bicycle, and a motorcycle.

Detecting an object in the blind spot area in operation 140 may include obtaining recognition information of the object included in the blind spot area and obtaining position information of the object included in the blind spot area. For example, the recognition information of the object located in the blind spot area and the position information of the object may be obtained from the first image and/or the second image through an object recognition algorithm such as scene segmentation and object detection. Object recognition information may include a class type related to an object type. For example, the class type may include a vehicle, a pedestrian, a bicycle, and a motorcycle based on an object classification. Object position information may refer to a value indicating a position of an object with respect to a vehicle, or a sensor capturing an image and may include three-dimensional (3D) position information including depth information of the object. A 3D position of the object may correspond to information estimated based on an algorithm for estimating position information, such as a depth estimation algorithm, from an image. Since the depth information of the object corresponds to the distance between the sensor and the object, the distance between the object and the vehicle in the blind spot area may be determined based on the depth information of the object such that the depth information of the object in the blind spot area is used to generate driving information.

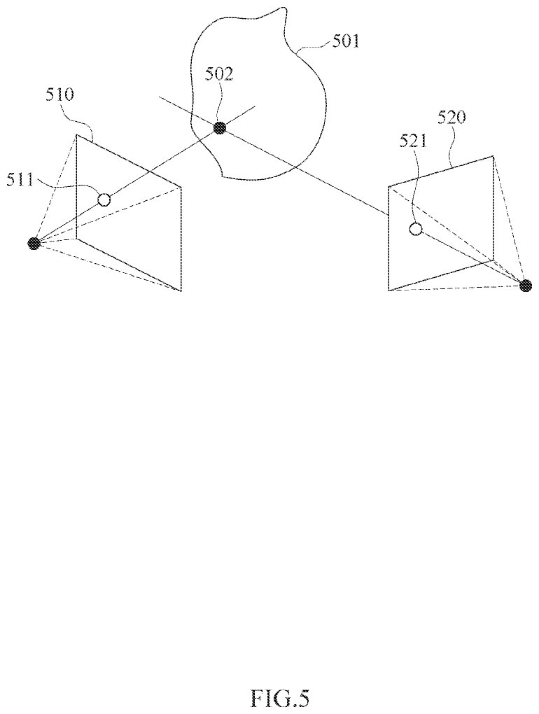

An area captured by the first ultra-wide-angle lens and an area captured by the second ultra-wide-angle lens may at least partially overlap with each other, and a partial region of the blind spot area may be included in both the first image and the second image. Object information detected from the first image and object information detected from the second image may be corrected by matching the first image with the second image. Image matching may refer to matching areas in which the same object is captured in a plurality of images. For example, referring to FIG. 5, image matching may refer to matching each pixel 511 of an image 510 to a pixel 521 obtained by capturing a same part 502 of another image 520 in the two images 510 and 520 obtained by capturing a same object 501 from different angles. Image matching may be performed using a variety of predetermined matching algorithms. Matching may be performed based on a position relationship of the first ultra-wide-angle lens and the second ultra-wide-angle lens by using a feature of the first ultra-wide-angle lens and the second ultra-wide-angle lens installed on a predetermined position in the vehicle, or a matching result based on a matching algorithm may be corrected.

Detecting the object in the blind spot area in operation 140 may include obtaining information of an object not detected in the first image based on the second image, based on a matching relationship between the object detected in the first image and the object detected in the second image. A matching relationship between a pixel of the first image and a pixel of the second image obtained by capturing the same part may be obtained from matching of the first image to the second image. A result of detecting an object in the blind spot area may be corrected based on a matching relationship between the first image and the second image. For example, the object in the blind spot area may be detected in the second image even when the object may not have been detected because the object is obscured by another object in the first image. Here, information associated with an object that is not detected in the first image may be obtained using a result of detecting the second image.

In other words, the accuracy for object detection may be improved by complementing a result of detecting the object in the first image and a result of detecting the object in the second image based on the matching of the first image and the second image. When determining whether an object is present in a blind spot area using one ultra-wide-angle lens, an error may occur in object detection due to an error of the ultra-wide-angle lens or an obstruction by another object. When a plurality of ultra-wide-angle lenses are used, another ultra-wide-angle lens may detect an object normally in the blind spot area even if one ultra-wide-angle lens does not detect the object in the blind spot area. In other words, the object in the blind spot area that is not detected in the image obtained from one ultra-wide-angle lens may be detected in the image obtained from another ultra-wide-angle lens by using the plurality of ultra-wide-angle lenses installed on the vehicle, thereby improving object detection accuracy.

The processor may improve object detection accuracy by adding detection results of the first image and the second image.

In an example, detecting the object in the blind spot area in operation 140 may include identifying the object in the blind spot area detected in both the first image and the second image by matching the first image and the second image and obtaining recognition information of the identified object based on first recognition information of the identified object detected from the first image and second recognition information of the identified object detected from the second image. The recognition information of the object may include a probability of the object corresponding to each class, and the class with the highest probability may be obtained as a recognition result of the object.

For example, when recognition accuracy for the first object is low because an image quality of an area including the first object corresponding to the vehicle is low, or the first object is obscured by other objects or positioned where accuracy may be reduced in terms of the angle, the recognition information of the first object detected from the first image may include a probability of 0.45 in which the first object corresponds to a vehicle and a probability of 0.55 in which the first object corresponds to a road. Meanwhile, the recognition information of the first object detected from the second image may include a probability of 0.95 in which the first object corresponds to a vehicle and a probability of 0.05 in which the first object corresponds to a road. Here, the first object may be recognized as a vehicle unlike the detection result of the first image by adding the recognition information of the first object detected in the first image and the recognition information of the first object detected in the second image. In other words, the accuracy of recognition information associated with the object may be improved based on a sum of object recognition results of the first image and the second image.

The obtaining of the recognition information of the identified object may include obtaining the recognition information of the identified object by calculating a weighted sum of the first recognition information and the second recognition information based on the reliability of the first image corresponding to the identified object and the reliability of the second image corresponding to the identified object. Reliability may be information obtained by performing an object recognition algorithm on an image. For example, when it is determined that there is a factor (e.g., an image quality of an area including the object being low or an object being obscured by other objects) in which the accuracy of recognition of a user is lowered, a low value may be determined. The reliability of the first image corresponding to the identified object and the reliability of the second image corresponding to the identified object may be used as weights, and a result having a large weight on the recognition information of images with high reliability may be obtained as recognition information of the object by calculating a weighted sum of the reliability of the first image corresponding to the identified object and the reliability of the second image corresponding to the identified object.

In another example, detecting the object in the blind spot area in operation 140 may include identifying the object in the blind spot area detected in both the first image and the second image by matching the first image and the second image and obtaining position information of the identified object based on first position information of the identified object detected in the first image and second position information of the identified object detected in the second image.

The position information of the object as described above may include a 3D position including the depth information of the object. The 3D position may be represented by a coordinate value on a coordinate system based on a set point. Similar to recognition information of the identified object being obtained, the position information of an object with improved accuracy may be obtained by adding position information associated with the object detected in the first image and position information associated with the object detected in the second image. When the position information on the object detected from the first image is summed with the position information on the object detected from the second image, an operation of converting the position information detected from the first image and the position information detected from the second image into position information corresponding to the same reference point may be included.

The obtaining of the position information of the identified object may include obtaining position information of the identified object by calculating a weighted sum of the position information of the first position information and the second position information based on the reliability of the first image corresponding to the identified object and the reliability of the second image corresponding to the identified object. The position information of the object detected in both the first image and the second image may be determined as an average value of the position information of the corresponding object detected in the first image and the position information of the corresponding object detected in the second image.

The obtaining of the position information of the identified object may include obtaining the position information of the identified object by correcting the first position information and the second position information based on a difference between the first position and the second position. The difference between the first position on which the first ultra-wide-angle lens for capturing the first image is installed and the second position on which the second ultra-wide-angle lens for capturing the second image is installed may correspond to a difference between depth values of the first image and the second image, and thus the first position information and the second position information may be corrected based on the difference.

Operation 150 may include generating information for driving control of the vehicle based on a result of monitoring a state of the driver and a state of the passengers of the vehicle and generating information for driving control of the vehicle based on the detection results of objects in the blind spot area. The information for driving control of the vehicle may be information generated to support the driver driving the vehicle and may include, for example, a signal including information for notifying the driver and a signal for controlling a device related to the driving of the vehicle.

For example, the processor may detect the state of the driver and the state of the passengers from the first image and the second image and generate a signal to warn the driver based on the identified result or may generate a signal for steering and controlling in connection with an advanced driver assistance system (ADAS) function of the vehicle. For example, when the driver is not looking forward with reference to a result of monitoring the state of the driver, a visual and/or audio signal to warn the driver to look forward may be generated. In another example, a signal for notifying the driver of the presence of a passenger may be generated with reference to a result of monitoring the state of the passenger. A signal for notifying the driver of the presence of the passenger may be provided based on a driving state of the vehicle. For example, when it is determined that the vehicle is no longer being driven, a signal for notifying the driver that the passenger is present in the vehicle may be generated to prevent the driver from leaving a baby inside the vehicle.

In another example, the processor may detect an object located in the blind spot area in the first image and the second image and may generate a signal to warn the driver based on the detection result, or a signal for steering and controlling the vehicle in connection with the ADAS function may be generated. For example, when the object located in the blind spot area is in a threshold value with the vehicle, a signal may be generated to notify the driver of the object's presence and position, or a signal may be generated to control the vehicle such that the vehicle does not move in the direction of the object.

FIG. 6 illustrates an example of a driving control apparatus of a vehicle.

Referring to FIG. 6, an apparatus 600 may include a processor 601, a memory 603, and a communication module 605. The apparatus 600 may include an apparatus for performing the driving control method described above with reference to FIGS. 1 to 5. For example, the apparatus 600 may be implemented in the form of a chip and mounted on a DMS and/or OMS module of the vehicle or may be implemented as a module that communicates with the vehicle to provide information needed for driving control of the vehicle.

The processor 601 may be a processing device implemented by hardware including a circuit having a physical structure to perform operations. For example, the operations may be implemented by execution of computer-readable instructions that configure the processing device to perform any one, or any combination, of the operations described.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA). Further details regarding the processor 601 is provided below.

The processor 601 may include one or more processors that perform one or more operations included in the driving control method described above with reference to FIGS. 1 to 5. For example, the processor 601 may obtain a first image captured by a first ultra-wide lens installed on a first position in a vehicle, obtain a second image captured by a second ultra-wide lens installed on a second position in the vehicle, monitor a state of a driver and a passenger of the vehicle based on the first image and the second image, detect an object in a blind spot area based on a matching of the first image and the second image, and generate information for driving control of the vehicle based on a result of the monitoring and a result of the detecting the object.

The memory 603 may be a volatile memory or a non-volatile memory. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), or an insulator resistance change memory. Further details regarding the memory 603 is provided below.

The memory 603 may store data related to the driving control method described above with reference to FIGS. 1 to 5. For example, the memory 603 may store data generated in the process of performing the driving control method or data needed to perform the driving control method. For example, the memory 603 may store the first image and the second image received from a sensor including a plurality of ultra-wide-angle lenses and may monitor the state of the driver and passengers of the vehicle in the first image and the second image. Results and detection results of objects in the blind spot area may be stored. In another example, the memory 603 may store code to perform an object detection algorithm and an algorithm for monitoring the state of a driver and a passenger of the vehicle.

The communication module 605 may provide a function for the apparatus 600 to communicate with another electronic device or another device through a network. In other words, the apparatus 600 may be connected to an external device (e.g., a personal computer (PC) or a network) through the communication module 605 to exchange data therewith. For example, when a first sensor including a first ultra-wide-angle lens and a second sensor including a second ultra-wide-angle lens correspond to an external device, the apparatus 600 may send and receive data to and from the first sensor and the second sensor through the communication module 605. In another example, the apparatus 600 may transmit information generated for driving control through the communication module 605 to an information transmission device such as a monitor, a speaker, and a dedicated display device.

The memory 603 may store a program that implements the driving control method described above with reference to FIGS. 1 to 5. The processor 601 may execute a program stored in the memory 603 and may control the apparatus 600. Code of the program executed by the processor 601 may be stored in the memory 603.

The apparatus 600 may further include other components (not shown). For example, the apparatus 600 may further include an I/O interface including an input device and an output device for interfacing with the communication module 605. In another example, the apparatus 600 may further include an input device including a first sensor and a second sensor and may further include an output device such as a monitor and a speaker for providing generated information. In addition, other components such as a transceiver, various sensors, and databases may be further included.

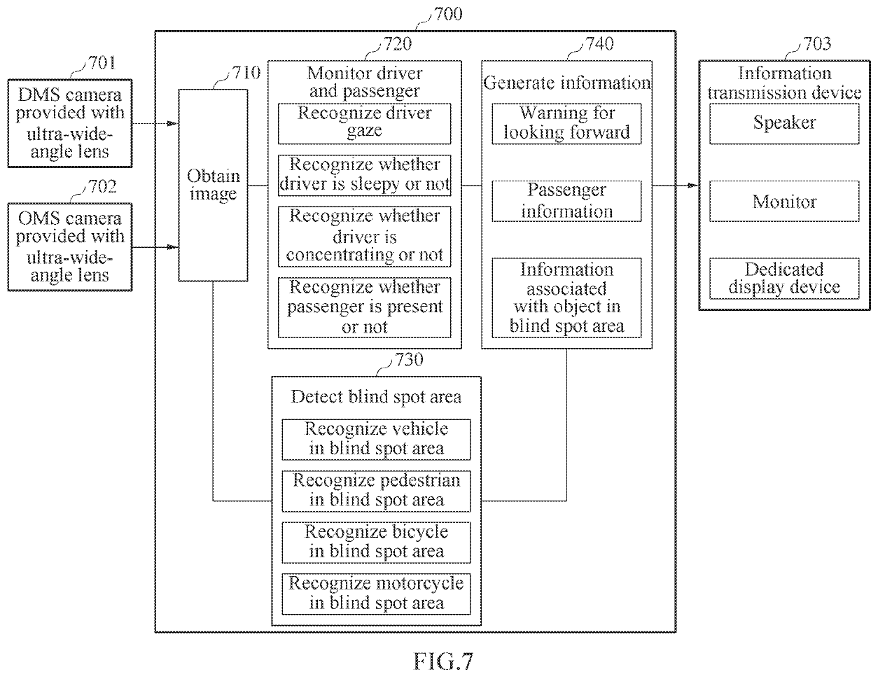

FIG. 7 illustrates an example of a driving control apparatus of a vehicle.

Referring to FIG. 7, an apparatus 700 may include an image acquisition module 710, a driver and passenger monitoring module 720, a blind spot detection module 730, and an information generation module 740. Modules (e.g., the image acquisition module 710, the driver and passenger monitoring module 720, the blind spot detection module 730, and the information generation module 740) included in the apparatus 700 illustrated in FIG. 7 may be examples of logical structures differentiated based on an operation performed by a device and do not limit a physical structure of the apparatus 700. The apparatus 700 for driving control may correspond to the apparatus 600 described above with reference to FIG. 6, and the modules, that is, the image acquisition module 710, the driver and passenger monitoring module 720, the blind spot detection module 730, and the information generation module 740 may be, include, or correspond to one or more processors.

The image acquisition module 710 may perform operations 110 and 120 described above with reference to FIG. 1. The image acquisition module 710 may receive a first image and a second image from a DMS camera 701 and an OMS camera 702. The DMS camera 701 and the OMS camera 702 may each correspond to a sensor provided with an ultra-wide-angle lens. For example, the DMS camera 701 may be installed on a first position corresponding to a center of a front row to capture a front seat of a vehicle, and the OMS camera 702 may be installed on a second position corresponding to a center of a back row to capture a back seat of the vehicle. While FIG. 7 illustrates the DMS camera 701 and the OMS camera 702 as external devices of the apparatus 700, the apparatus 700 may include the DMS camera 701 and the OMS camera 702. In an example, the image acquisition module 710, the driver and passenger monitoring module 720, the blind spot detection module 730, and the information generation module 740 may also be referred to as the image acquirer 710, the driver and passenger monitor 720, the blind spot detector 730, and the information generator 740.

The driver and passenger monitoring module 720 may perform operation 130 described above with reference to FIG. 1. For example, the driver and passenger monitoring module 720 may perform an operation for recognizing the driver's gaze, recognizing whether the driver is sleepy or not, recognizing whether the driver is concentrating or not, and/or recognizing whether the passenger is present based on the first image and the second image.

The blind spot detection module 730 may perform operation 140 described above with reference to FIG. 1. For example, the blind spot detection module 730 may perform an operation of detecting and recognizing an object including a vehicle, a pedestrian, a bicycle, and a motorcycle in the blind spot area.

The information generation module 740 may perform operation 150 described above with reference to FIG. 1. For example, the information generation module 740 may generate a signal for warning the driver to look forward and/or a signal for providing passenger information based on a monitoring result of the driver and passenger monitoring module 720 and may generate a signal for notifying information associated with an object in a blind spot area to the driver and/or a signal for controlling an apparatus related to the driving of the vehicle based on the object detection result of the blind spot detection module 730.

A signal generated by the information generation module 740 may be output through an information transmission device 703. The information transmission device 703 may include a speaker for outputting an auditory signal, a monitor for outputting a visual signal, and may include a dedicated display device for outputting a signal generated by the information generation module 740. At least a part of the information transmission device 703 may be included in the vehicle or may be included in the driver's terminal interlocked with the vehicle. While FIG. 7 illustrates the information transmission device 703 as an external device of the apparatus 700, the apparatus 700 may include at least a part of the information transmission device 703.

The vehicles, apparatuses, processors, memories, communication modules, cameras, image acquisition modules, driver and passenger monitoring modules, blind spot detection modules, information generation modules, DMS cameras, OMS cameras, information transmission devices, apparatus 600, processor 601, memory 603, communication module 605, apparatus 700, image acquisition module 710, driver and passenger monitoring module 720, blind spot detection module 730, information generation module 740, DMS camera 701, OMS camera 702, information transmission device 703, and other apparatuses, units, modules, devices, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner.

The methods illustrated in FIGS. 1-7 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In an example, the instructions or software includes at least one of an applet, a dynamic link library (DLL), middleware, firmware, a device driver, an application program storing the driving control method. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method with driving control, the method comprising:
obtaining a first image captured by a first ultra-wide-angle lens disposed on a first position in a vehicle;
obtaining a second image captured by a second ultra-wide-angle lens disposed on a second position in the vehicle;
monitoring a state of a driver and an occupant of the vehicle based on the first image and the second image;
detecting an object in a blind spot area based on a matching of the first image and the second image; and
generating information for control of the vehicle based on a result of the monitoring and a result of the detecting of the object.

2. The method of claim 1, wherein the detecting of the object in the blind spot area comprises:
obtaining information of an object not detected in the first image based on the second image, based on a matching relationship between an object detected in the first image and an object detected in the second image.

3. The method of claim 1, wherein the detecting of the object in the blind spot area comprises:
identifying an object in the blind spot area detected in both the first image and the second image by matching the first image and the second image; and
obtaining recognition information of the identified object based on first recognition information of the identified object detected in the first image and second recognition information of the identified object detected in the second image.

4. The method of claim 3, wherein the obtaining of the recognition information of the identified object comprises:
obtaining recognition information of the identified object by calculating a weighted sum of the first recognition information and the second recognition information based on a reliability of the first image corresponding to the identified object and a reliability of the second image corresponding to the identified object.

5. The method of claim 1, wherein the detecting of the object in the blind spot area comprises:
identifying, in the blind spot area, an object detected in both the first image and the second image by matching the first image and the second image; and
obtaining position information of the identified object based on first position information of the identified image detected in the first image and second position information of the identified image detected in the second image.

6. The method of claim 5, wherein the obtaining of the position information of the identified object comprises:
obtaining the position information of the identified object by calculating a weighted sum of the first position information and the second position information based on a reliability of the first image corresponding to the identified object and a reliability of the second image corresponding to the identified object.

7. The method of claim 5, wherein the obtaining of the position information of the identified object comprises:
obtaining the position information of the identified object by correcting the first position information and the second position information based on a difference between the first position and the second position.

8. The method of claim 1, wherein the detecting of the object in the blind spot area comprises:
obtaining recognition information of the object comprised in the blind spot area; and
obtaining position information of the object comprised in the blind spot area.

9. The method of claim 1, wherein the monitoring of the state of the driver and the occupant of the vehicle based on the first image and the second image comprises:
detecting the driver of the vehicle and the occupant of the vehicle based on information of an inner area of the vehicle in the first image and the second image; and
monitoring the detected state of the driver and the detected state of the occupant.

10. The method of claim 1, the first ultra-wide-angle lens is disposed on the first position comprises a driver monitoring system (DMS) camera for capturing a front seat of the vehicle, and the second ultra-wide-angle lens is disposed on the second position comprises an occupant monitoring system (OMS) camera for capturing a back seat of the vehicle.

11. A non-transitory computer-readable storage medium storing instructions that, when executed by one or more processors, configure the one or more processors to perform the method of claim 1.

12. An apparatus with driving control, the apparatus comprising:
one or more processors configured to:
obtain a first image captured by a first ultra-wide-angle lens disposed on a first position in a vehicle;
obtain a second image captured by a second ultra-wide-angle lens disposed on a second position in the vehicle;
monitor a state of a driver and an occupant of the vehicle based on the first image and the second image;
detect an object in a blind spot area based on a matching of the first image and the second image; and
generate information for control of the vehicle based on a result of the monitoring and a result of the detecting of the object.

13. The apparatus of claim 12, wherein the one or more processors are further configured to:
obtain information of an object not detected in the first image based on the second image, based on a matching relationship between an object detected in the first image and an object detected in the second image.

14. The apparatus of claim 12, wherein the one or more processors are further configured to:
identify an object in the blind spot area detected in both the first image and the second image by matching the first image and the second image; and
obtain recognition information of the identified object based on first recognition information of the identified object detected in the first image and second recognition information of the identified object detected in the second image.

15. The apparatus of claim 12, wherein the one or more processors are further configured to:
obtain recognition information of the identified object by calculating a weighted sum of the first recognition information and the second recognition information based on a reliability of the first image corresponding to the identified object and a reliability of the second image corresponding to the identified object.

16. The apparatus of claim 12, wherein the one or more processors are further configured to:
identify, in the blind spot area, an object detected in both the first image and the second image by matching the first image and the second image; and
obtain position information of the identified object based on first position information of the identified image detected in the first image and second position information of the identified image detected in the second image.

17. The apparatus of claim 16, wherein the one or more processors are further configured to:
obtain the position information of the identified object by calculating a weighted sum of the first position information and the second position information based on a reliability of the first image corresponding to the identified object and a reliability of the second image corresponding to the identified object.

18. The apparatus of claim 16, wherein the one or more processors are further configured to:
obtain the position information of the identified object by correcting the first position information and the second position information based on a difference between the first position and the second position.

19. The apparatus of claim 12, wherein the one or more processors are further configured to:
obtain recognition information of the object comprised in the blind spot area; and
obtain position information of the object comprised in the blind spot area.

20. The apparatus of claim 12, wherein the one or more processors are further configured to:
detect the driver of the vehicle and the occupant of the vehicle based on information of an inner area of the vehicle in the first image and the second image; and
monitor the detected state of the driver and the detected state of the occupant.
